(19) United States
(12) Patent Application Publication
(10) Pub. No.: US 2012/0268604 A1
(43) Pub. Date: Oct. 25, 2012

(54) DUMMY SECURITY DEVICE THAT MIMICS AN ACTIVE SECURITY DEVICE

(76) Inventor: Evan Tree, Sandy, UT (US)

(21) Appl. No.: 13/455,890

(22) Filed: Apr. 25, 2012

Related U.S. Application Data
(60) Provisional application No. 61/478,824, filed on Apr. 25, 2011.

(51) Int. Cl. H04N 7/18; G08B 13/00

(52) U.S. Cl. 348/152; 340/541; 348/E07.085

(57) ABSTRACT

A dummy security device that includes some means of drawing attention to itself using a visual and/or audible means to thereby draw attention to the presence of the dummy security device, wherein the fact that the device is not a real security device is hidden from view, wherein the dummy security device is relatively inexpensive to purchase to thereby promote installation of many of the devices, and wherein an active detection means may be employed to enable the dummy security device to provide a visual and/or audible indication that the presence of a person has been detected.

### CROSS REFERENCE TO RELATED APPLICATIONS

This document claims priority to and incorporates by reference all of the subject matter included in the provisional patent application docket number 4958.RDOT.PR, having Ser. No. 61/478,824, filed Apr. 25, 2011.

### BACKGROUND OF THE INVENTION

1. Field of the Invention

This invention relates generally to security devices that are used for commercial, residential and automobile security purposes. More specifically, a dummy security device is intended not only to be seen but to actively draw attention to itself for the purpose of informing a viewer that security is important at the location it is being seen and thereby acting as a deterrence to criminal activity.

2. Description of Related Art

Security devices are typically put in place to act as deterrence to criminal activity such as theft or vandalizing. Such security devices include but are not limited to active security devices such as cameras, motion sensors, and alarms. The purpose of these active security devices is to generally function as some sort of a warning that a particular object or location is being protected from criminal activities.

For example, security cameras can not only record images of people for review at a later time, but can by their very presence discourage criminal activity because a potential criminal knows that they might be identified and apprehended based on the recorded image. In other words, when a potential criminal sees a warning sign advertising an alarm or protected. premises, a sticker advertising security cameras, a motion sensor or a security camera, the potential criminal may be less likely to commit a criminal act because the chances of being caught are increased.

However, the number of automobiles, homes or other buildings that owners would like to protect far exceeds the monetary resources of those who want to protect them. If this was not true, many more security devices would be in use. Therefore, one of the largest problems preventing the more ubiquitous use of security devices is that they can be relatively expensive. The result is that owners often either decline to spend the money necessary to install security devices in all the locations that they are needed, or decline to install any at all.

Accordingly, it would be an advantage over the state of the art in security devices to provide a method and apparatus for installing security devices at a significantly reduced cost to an owner.

### BRIEF SUMMARY OF THE INVENTION

The present invention is a dummy security device that includes some means of drawing attention to itself using a visual and/or audible means to thereby draw attention to the presence of the dummy security device, wherein the fact that the device is not a real security device is hidden from view, wherein the dummy security device is relatively inexpensive to purchase to thereby promote installation of many of the devices, and wherein an active detection means may be employed to enable the dummy security device to provide a visual and/or audible indication that the presence of a person has been detected.

These and other objects, features, advantages and alternative aspects of the present invention will become apparent to those skilled in the art from a consideration of the following detailed description. taken in combination with the accompanying drawings.

### BRIEF DESCRIPTION OF THE SEVERAL VIEWS OF THE DRAWINGS

FIG. 1 is a perspective view of a dummy security device.

FIG. 2 is a perspective view of the dummy security device of FIG. 1 with a visual display thereon to attract the attention of a potential criminal.

FIG. 3 is a block diagram of a control unit of the present invention.

FIG. 4 is a front view of a decal having a single LED light.

FIG. 5 is a perspective view of a decal having a plurality of LED lights.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

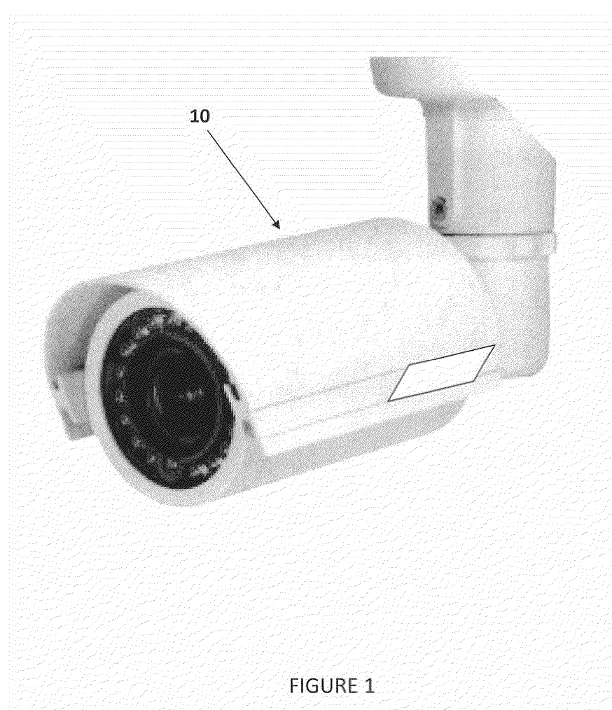

In a first embodiment of the present invention shown in FIG. 1, a dummy security device is shown. It should be understood that this dummy security device can look like any security device that is currently in use. In the example shown in FIG. 1, the dummy security device is a fake or non-operational video camera 10. The dummy video camera 10 should appear as a complete housing, but need not have any working components. However, it should be understood that even an operational video camera or a previously operational video camera can also be used and should be considered to be within the scope of the present invention.

The possible inoperative or dummy security devices that might be used include, but should not be considered to be limited to, a video camera, a motion. sensor, a thermal or infrared sensor, a radio frequency detector, etc. What should be understood is that the dummy security device can be made to look like any real security device, even if it is not performing the real function.

It should also be understood that it would be advantageous if the dummy security device can be made to be an exact replica of any real security device. In this way, a potential criminal does not know if the security device that can be seen is a real security device or a fake. This inability to know if the security device is fake or real serves as the basis for preventing criminal, activity ii the potential criminal thinks that the risk is too high to take without knowing if the security device is fake or real.

Therefore, even though it will be common knowledge that dummy security devices are being sold, possibly in large numbers, this knowledge will not help the potential criminal because real security devices might also be installed along with a mixture of dummy security devices. To further prevent identification of a dummy security device as a real security device, the dummy security device might also come with features that make the dummy security devices to not appear all the same. These features include but should not be considered limited to physical features such as antenna, wiring, cabling and electrical connections, hoods, shades, stickers, decals or any other feature that would not interfere with operation if the security device as not fake.

The dummy security device will be installed in any of the locations that a real security device would he installed so that nothing about the location of the device, or how it appears to be installed, would indicate that it is anything but a real security device. Therefore, the dummy security device would be installed on windows, doors, mailboxes, yard signs, automobile dashboards, mirrors, fences, or any other location that a real security device might be installed.

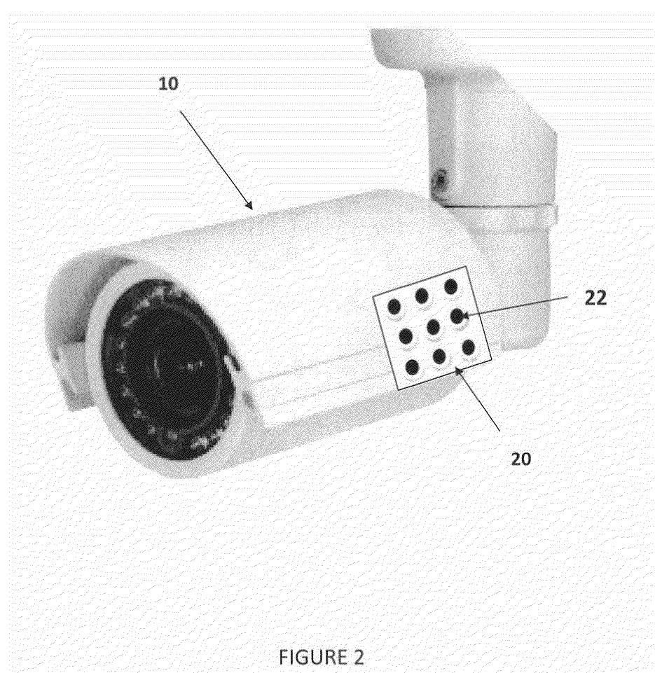

Another aspect of the present invention is shown in FIG. 2. FIG. 2 is another view of the dummy security device 10 of FIG. 1 but with a visual display 20 disposed thereon. It is important that the visual display be easily seen by a potential criminal. By changing the visual display 20, the dummy security device 10 is drawn to the attention of the potential criminal. By making the potential criminal immediately aware of the presence of the device 10, criminal activity is discouraged.

Furthermore, the way in which the visual display 20 is changed will also further the purposes of protection. For example, the visual display 20 might include a single light or a plurality of lights that simply blink in unison to indicate that the dummy security device 10 is active. The plurality of lights might be made to turn on and off in a pseudo-random pattern to draw more attention to the dummy security device 10. In addition, the plurality of lights might also be made to change in response to stimulus.

The stimulus might come from a real form, of potential criminal detection. For example, a simple motion sensor could be used so that if the potential criminal decides to risk movement nearer to the dummy security device, the visual display would change in response to the closer presence of the potential criminal. Thus if the potential criminal believed the device to be fake, the change in the visual display would be an unmistakable signal to the potential criminal that his/her presence has been detected, and the visual display is responding to a presence.

In a first embodiment of the visual display of FIG. 2, the visual, display 20 is a plurality of LED lights 22 that might display a pseudo-random pattern. The pattern could also be changed if the presence of a potential criminal is detected.

In an alternative embodiment, the visual display 20 is a plurality of any lights that is grouped in any convenient manner to enable the display of recognizable patterns.

It is a function of the present invention that no detectable pattern in the visual display 20 be seen, unless a pattern is wanted to be shown. For example, the flashing of LED lights might appear to be pseudo-random until a potential criminal is detected, and then the pattern might change to be a recognizable and distinct pattern so that the potential criminal can know almost instantly that the dummy security device 10 is reacting to his/her presence. For example, the pseudo-random pattern might be a random blinking of the plurality of LED lights 22, and the recognizable pattern might be a change to a solid blinking on and off of the plurality of LED lights 22 in unison, or some other desired and recognizable pattern.

The visual display 20 might go further than. to lust display lights in some visible but meaningless pattern. For example, a readable message could be shown on a more elaborate visual display that would be a message directly to the potential criminal telling him/her to leave immediately, or any other desired action.

The dummy security device 10 would include some means for controlling what is seen on the visual display. The dummy security device 10 would therefore include some sort of processing capability to control the display of pseudo-random patterns of light, recognizable patterns of light, or even text messages.

In another aspect of the present invention, the size of the dummy security device 10 can vary greatly. If the visual display 20 is energy efficient, then the dummy security device 10 could be powered by something as small as a button battery or small AAA or AA cell batteries all the way up to larger D cell batteries or even a transformer that is plugged into an alternating current source. Thus, because the power source can be small, the dummy security device 10 can also be relatively small. This enables the dummy security device 10 to be easily mountable in places that might otherwise be difficult to install a security device. The advantage to the present invention is that the more visible the dummy security device 10 is to a potential criminal, the sooner that the criminal activity might be prevented.

For example, a simple suction cup might be used to mount the dummy security device 10 on a window. What is important is that the dummy security device should be easily seen. If the dummy security device 10 is to perform its function, it should be easily visible during the day or night. Thus, the location of the dummy security device 10 along with a visual and/or audible indication means is important to the effectiveness of the present invention.

An audible indicator might be a chirping noise that is emitted by smoke detectors or other small electronic devices. The audible indicator might also be a pre-recorded voice message with a warning to the potential criminal. The audible indicator would be activated when the presence of a potential criminal is detected.

Another aspect of the present invention is that detection of a potential criminal is not limited only to motion. Therefore the present invention should be considered to include, but not be limited to, pressure sensors, capacitive sensors, thermal or infra-red sensors and motion sensors.

Alternatively, the sensor of the dummy security device 10 could also include means for detecting the presence of an object being carried by the potential criminal, such as an RF detector that can detect the presence of a mobile telephone. What is important is that the scope of sensors that can be used by the present invention should not be considered to be limited to those named above, but should include any means for detecting a potential criminal or a device that the potential criminal might be carrying if it can be detected.

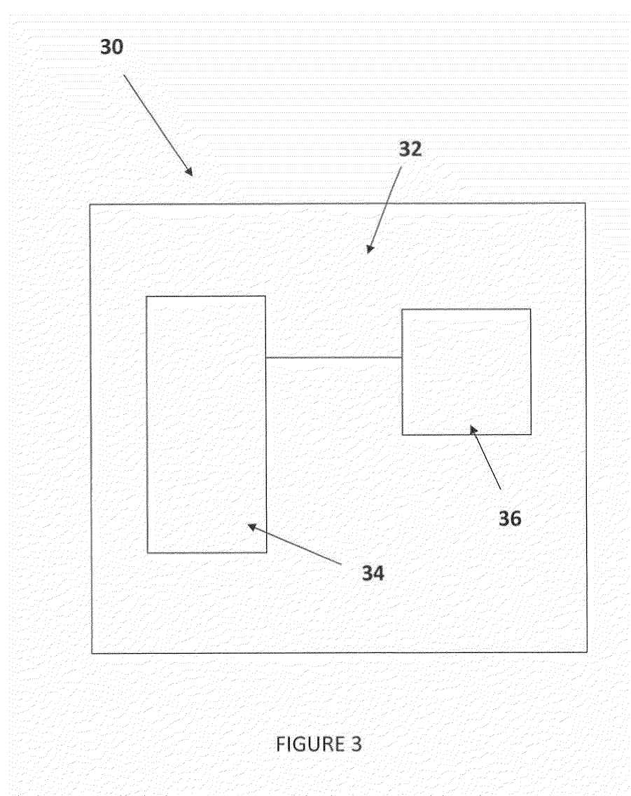

FIG. 3 shows in a block diagram the implementation of toe present invention that will involve a control unit 30 having at least a printed circuit board 32 having a microprocessor 34 with some access to a memory unit 36. The control unit 30 can be powered by a battery or from a plug that is coupled to a source of alternating current. The shape of the control unit 30 can be modified to conform to a variety of different housing units or to have a specific visual profile, such as to fit within a logo or other design of the user. The control unit 30 is capable of controlling a visual display and/or audible signal,

In another aspect of the present invention, a light sensor such as a photosensitive cell could be coupled to the control unit to disable the visual display during daylight hours if desired.

In another aspect of the invention, the control unit 30 might include an energy storage unit that might be charged by a solar cell during daylight, and which would power the control unit during the night. The control unit could also be powered during the day directly from the solar cell.

It is envisioned that the present invention is likely to be installed along with fully operational security devices in order to expand the overall coverage of a security system. By having dummy security devices with visual indicators such as flashing LED lights 22, potential criminals are put on notice from a distance that the property should not be approached. Prior art decals giving information about an alarm system are typically not visible from a great distance, and the potential criminal is close to the property before the decals are noticed. By making the decal 40 more visible from a longer distance, the potential criminal is kept as far from a structure as possible.

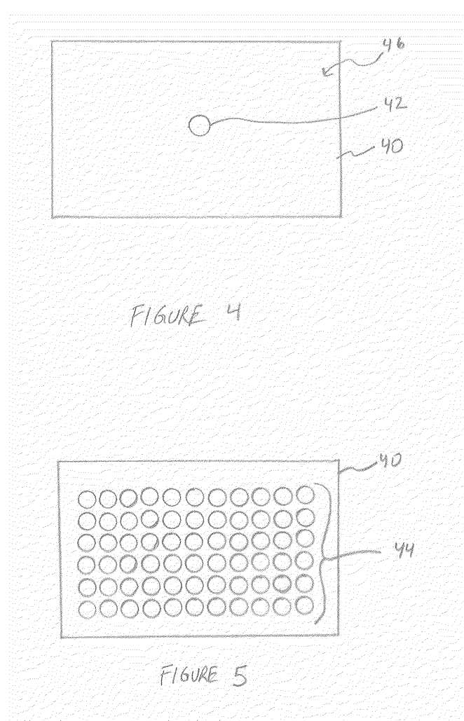

FIG. 4 is another embodiment of the present invention that shows a decal 40 that is placed on a window, door or other location that is visible on a structure or object being protected. The decal 40 may include an adhesive front surface 46 so that it can be mounted on the inside surface of a window, or an adhesive back surface (not shown) so that it can be mounted on a structure other than a window, such as a door. The decal 40 includes at least one light such as a single LED 42. The single LED 42 is powered by a battery within the device. The battery may be accessed on a backside of the decal 40. The battery, such as a small watch button battery, and the electronics necessary to control the single LED 42 are small and lightweight, and do not interfere with placement of the decal 40 on a window. With constant flashing of the LED light 42 it is still possible to obtain months of use from the battery before it needs to be replaced. Accordingly, the decal 40 will provide more visibility for advertising the presence of a security system during the day and night as compared to a regular decal. The decal 40 can be made flexible or rigid.

In another embodiment of the present invention shown in FIG. 5, the decal 40 can include a plurality of LEDs 44. The plurality of LEDs 44 can provide more information than a single LED. For example, a pattern, letters, words or more than one color can be displayed. The lightweight nature of the plurality of LEDs 44 also lends themselves to making the decal 40 lightweight so that it can still be adhered to a window. The decal 40 can also be made to be flexible or rigid when using the plurality of LEDs

In another embodiment of the present invention, the decal 40 can be used not only as a warning device, but also as a signaling device to guide emergency responders to a specific location. For example, consider a decal 40 that is disposed on a window. Emergency responders can be lead to access to a window if other access is blocked. Thus, the decal 40 can be used as a signal of distress if help is needed. The help needed can be medical assistance, fire response or police response. A unique LED color, pattern of flashing or any other means for signaling with a light or lights on the decal 40 or the dummy security device should be considered to be within the scope of the present invention.

In another embodiment of the present invention, the single LED 42 or the plurality of LEDs 44 can be controlled by another remotely by another device or operated manually. For example, if a burglar alarm or a smoke alarm were to be activated, the burglar alarm, the smoke alarm or another device monitoring the burglar alarm or smoke alarm could send a signal to the decals 40 or the dummy security devices to send a distress signal and guide emergency responders to window access, or any other convenient access location.

In another embodiment of the present invention, the decal 40 or the dummy security device are also equipped with a sensor to determine the amount of ambient light. The surrounding brightness can then be used to adjust the brightness of any LEDs that are flashing, and thereby conserve power or be more effective for the particular light conditions.

The LED 42 or plurality of LEDs 44 should also be considered to have the ability to change a pattern of flashing or a color of flashing in order to respond to stimulus and more easily indicate that the presence of a person has been detected. Accordingly, the decal 40 may include a motion sensor or other type of sensor in order to he able to respond to a person.

A final embodiment of the present invention is the use of a low cost and low cost image sensor that can take snapshots and store them in non-volatile memory for later retrieval

It is to be understood that the above-described arrangements are only illustrative of the application of the principles of the present invention. Numerous modifications and alternative arrangements may he devised by those skilled in the art without departing from the spirit and scope of the present invention. The appended claims are intended to cover such modifications and arrangements.

What is claimed is:

1. A method for providing a visual indication that a person has been detected by a dummy security device, said method comprising the steps of:
(1) placing a dummy security device in a location that is visible to an observer;
(2) providing the dummy security device with a means for detecting a person; and
(3) activating a plurality of lights on the dummy security device, and causing the plurality of lights to provide a visual indication that the person is detected.

2. The method as defined in claim 1 wherein the step of providing the means for detecting a person further comprises the step of selecting the means from the group of means for detecting a person comprising: a motion sensor, a visual sensor, a thermal sensor, an infra-red sensor, a pressure sensor, a capacitive sensor and a radio frequency sensor.

3. The method as defined in claim 1 wherein the step of providing a dummy security device further comprises the step of providing a security decal as the dummy security device.

4. The method as defined in claim I wherein the method further comprises the step of activating the plurality of lights such that the plurality of lights are visible to the observes before the person is detected.

5. The method as defined in claim 4 wherein the step of activating the plurality of lights further comprises causing the plurality of lights to display a pseudo-random pattern of lights.

6. The method as defined in claim 1 wherein the step of providing a visual indication that the person is detected further comprises the step of showing a visual indication that is different from the visual indication that is shown before a person is detected.

7. The method as defined in claim 6 wherein the method further comprises the step of changing the visual display when the person is no longer detected.

8. The method as defined in claim 7 wherein the method further comprises the step of returning the visual display to a same visual display before the person was detected.

9. The method as defined in claim 6 wherein the step of showing a visual indication further comprises the step of selecting a visual indication from the group of visual indications comprising: changing a color of the plurality of lights, flashing the plurality of lights in a repeating pattern, displaying a readable message, and changing a brightness of the plurality of lights.

10. The method as defined in claim 6 wherein the method further comprises the step of making the visual indication programmable.

11. The method as defined in claim 1 wherein the method further comprises the step of adding physical features to the dummy security device so that the dummy security device appears physically different from other dummy security devices.

12. The method as defined in claim 11 wherein the step of adding physical features to the dummy security device further comprises the step of selecting the physical features from the group of physical features comprising: antenna, wiring, cabling and electrical connections, hoods, shades, stickers, and decals.

13. The method as defined in claim 1 wherein the method further comprises the step of providing a speaker to thereby provide an audible indicator that the person is detected.

14. The method as defined in claim 1 wherein the method further comprises the step of using the dummy security device as a signaling device that is capable of attracting the attention of emergency responders.

15. The method as defined in claim 1 wherein the method further comprises the step of providing a means for sending a signal to the dummy security device so that the visual indication will, generate a signal that is designed to attract the attention of emergency responders.

16. The method as defined in claim 1 wherein the method further comprises the step of providing an ambient light sensor to thereby make adjustments to the visual indication based upon ambient light conditions.

17. The method as defined in claim 1 wherein the method further comprises the step of providing an image sensor that enables the dummy security device to take and store visual images.

18. The method as defined in claim 1 wherein the step of providing a dummy security device further comprises the step of selecting the dummy security device from the group of dummy security devices comprised of: a video camera and an electronic sensor.

19. A method for providing a visual indication that a person has been detected by a security decal device, said method comprising the steps of:
(1) placing a security decal device in a location that is visible to an observer;
(2) providing the security decal device with a means for detecting a person; and
(3) activating a plurality of lights on the security decal device, and causing the plurality of lights to provide a visual indication that the person is detected.

20. A dummy security device for providing a visual indication that a person has been detected, said dummy security device comprised of:
a housing for the dummy security system that has a physical appearance of performing a security feature;
means for mounting the housing in a visible location;
means for detecting a person; and
a plurality of lights on the housing for providing a visual indication that the person is detected.
